(19) United States
(12) Patent Application Publication
(10) Pub. No.: US 2021/0100402 A1
(43) Pub. Date: Apr. 8, 2021

(54) DISPENSER OF DISPOSABLE CONTAINERS FOR THE PREPARATION OF BEVERAGES

(71) Applicant: EVOCA S.P.A., Milano (IT)

(72) Inventor: Emanuele Masciandaro, Milano (IT)

(21) Appl. No.: 16/500,061

(22) PCT Filed: Apr. 20, 2018
(86) PCT No.: PCT/IB2018/052772

§ 371 Date: Oct. 1, 2019

(30) Foreign Application Priority Data
Apr. 20, 2017 (IT) 102017000043567

(51) Int. Cl. A47J 47/01; A47G 23/02; A47J 31/44

(52) U.S. Cl. CPC A47J 47/01; A47J 31/44; A47G 23/0208

(57) ABSTRACT

A dispenser of disposable containers for the preparation of beverages has a hopper to contain a plurality of disposable containers, a discharge unit to discharge the disposable containers, and a dispensing wheel, which receives disposable containers from the hopper, dispenses disposable containers to the discharge unit, is interchangeable to reconfigure the dispenser depending on the shape and/or size of the disposable containers, and is releasably connectable to an actuating device of the dispensing wheel.

### PRIORITY CLAIM

This application claims priority from Italian Patent Application No. 102017000043567 filed on Apr. 20, 2017, the disclosure of which is incorporated by reference.

### TECHNICAL FIELD

The present invention relates to a dispenser of disposable containers for the preparation of beverages.

In particular, the present invention relates to a dispenser of disposable containers for the preparation of beverages of the type comprising a hopper to contain a plurality of disposable containers; a discharge unit to discharge the disposable containers; and a dispensing wheel mounted to rotate about a rotation axis to receive the disposable containers from the hopper and dispense the disposable containers to the discharge unit.

The dispensing wheel comprises a plurality of pockets each designed to receive at least one disposable container and fed by the dispensing wheel above a dispensing plate with an opening to discharge the disposable containers in an output channel of the discharge unit.

The dispenser further comprises an actuating device mounted in the discharge unit to move the dispensing wheel around the rotation axis.

Generally, the actuating device comprises an electric motor, and a gear train to connect an output shaft of the electric motor to an input shaft of the dispensing wheel.

### STATE OF THE ART

Dispenser of disposable containers for the preparation of beverages are known, for example, from WO0184514, WO2015100133, WO2005104047, U.S. Pat. No. 869,635.

known dispensers of disposable containers for the preparation of beverages of the above-described type have some drawbacks mainly deriving from the fact that the replacement of the disposable containers with disposable containers of a different shape and/or size requires the replacement of the entire dispenser each time. As a result, shape and/or size change operations are relatively expensive and involve the storage of a relatively large number of dispensers.

### OBJECT AND SUMMARY OF THE INVENTION

The object of the present invention is to provide a dispenser of disposable containers for the preparation of beverages which is free from the above-described drawbacks and which is simple and inexpensive to implement.

According to the present invention, a dispenser of disposable containers for the preparation of beverages is provided, as claimed in the appended claims.

### BRIEF DESCRIPTION OF THE DRAWINGS

The present invention will now be described with reference to the accompanying drawings, which show a non-limitative embodiment thereof, wherein:

FIG. 1 is a schematic perspective view, with parts removed for clarity, of a preferred embodiment of the dispenser of the present invention;

FIG. 2 is an exploded perspective view, with parts removed for clarity, of the dispenser of FIG. 1;

FIG. 3 is an exploded perspective view, with parts removed for clarity, of a detail of FIG. 2;

FIG. 4 is a schematic perspective view, with parts in section and parts removed for clarity, of the dispenser of FIG. 1;

FIG. 5 is a schematic perspective view, with parts removed for clarity, of a first alternative of the dispenser of FIG. 1; and

FIG. 6 is a schematic perspective view, with parts removed for clarity, of a second alternative of the dispenser of FIG. 1.

### PREFERRED EMBODIMENTS OF THE INVENTION

With reference to Figures from 1 to 4, number 1 denotes, as a whole, a dispenser of disposable containers 2 for the preparation of beverages.

The dispenser 1 comprises a hopper 3 of a known type, which is designed to contain a plurality of containers 2 and has a downwardly facing converging shape.

The hopper 3 comprises an input end 4, which has a substantially rectangular shape, and extends perpendicularly to a substantially vertical direction 5; and an output end 6, which has a substantially circular shape, and extends perpendicularly to a direction 7 inclined with respect both to a horizontal reference plane and to a vertical reference plane.

The dispenser 1 is further provided with a discharge unit 8 comprising a tubular body 9, which projects downwards from the hopper 3, and is hooked to the output end 6, and a discharge channel 10, which projects downwards from the body 9 to discharge the containers 2 outside the dispenser 1.

The dispenser 1 further comprises a pocketed dispensing wheel 11, which is housed in the body 9, and is mounted to rotate around a rotation axis 12 parallel to the direction 7.

The wheel 11 has a plurality of dragging members 13, which are evenly distributed around the axis 12, have a substantially flat shape, and extend radially towards the outside from an outer surface of the wheel 11.

Each element 13 defines, together with each adjacent element 13, a pocket 14, which is configured to contain a respective container 2, and is fed by the wheel 11 above a dispensing plate 15.

The plate 15 closes the body 9 at the bottom and, hence, the pockets 14, is mounted perpendicular to the direction 7, and has an opening 16 to discharge the containers 2 into the channel 10.

The wheel 11 is rotated about the axis 12 by an actuating device 17, which defines part of the discharge unit 8, and comprises a box-like body 18 fixed below the plate 15, an electric motor 19 projecting downwards from the body 18, and a gear train 20 housed in the body 18 to connect an output shaft (not shown) of the engine 19 and an input shaft 21 of the wheel 11 to one another.

The shaft 21 has a substantially parallelepiped shape, and is bounded by at least one flat face, in the embodiment two flat faces parallel and opposite to one another, to shape couple to one gear in an angularly fixed manner, hereinafter denoted with 20a, of the gear train 20 through a positive mechanical engagement.

The wheel 11 is interchangeable to reconfigure the dispenser 1 depending on the shape and/or size of the containers 2, and is releasably axially locked onto the gear 20a via a coupling device 22.

The device 22 comprises a pair of elastically deformable projections 23, which are formed at a free end of the shaft 21, and are each provided with a respective tooth 24 projecting radially towards the outside from the respective projection 23.

The two projections 23 are configured to extend through the gear 20a following an insertion movement of the shaft 21 through the gear 20a and so as to allow the teeth 24 to axially lock the shaft 21 onto the gear 20a.

Replacement of the wheel 11 requires only disengagement of the teeth 24 from the gear 20a and of the shaft 21 from the gear 20a.

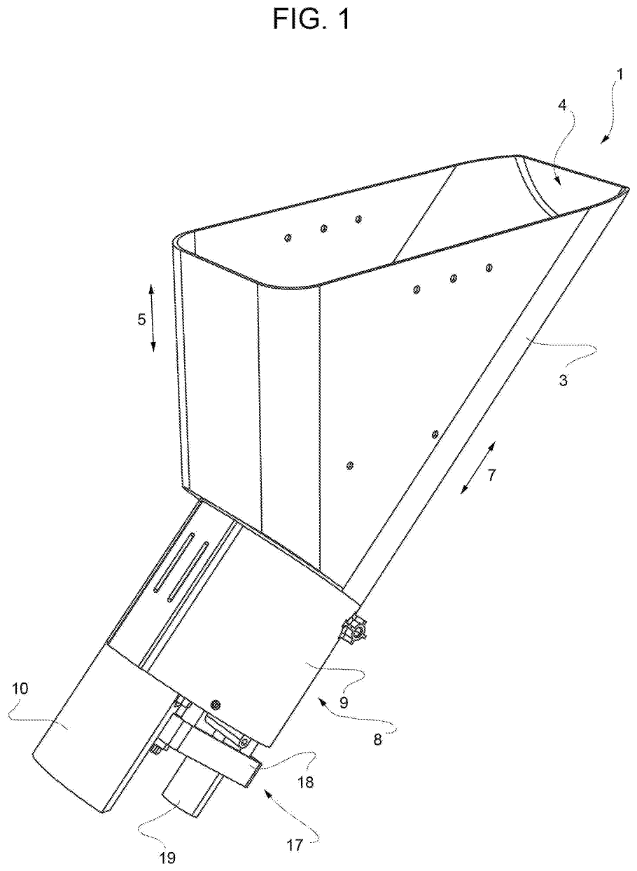

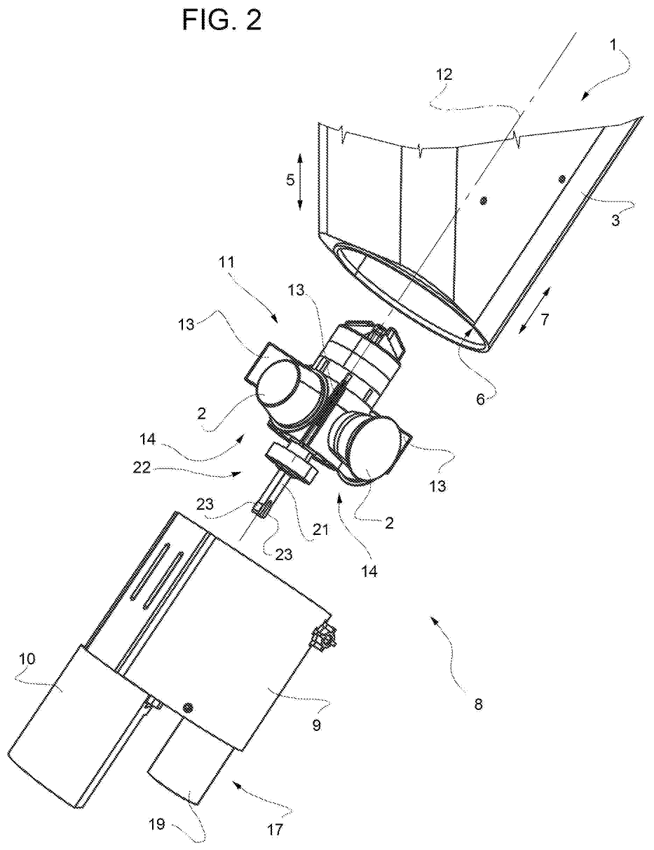

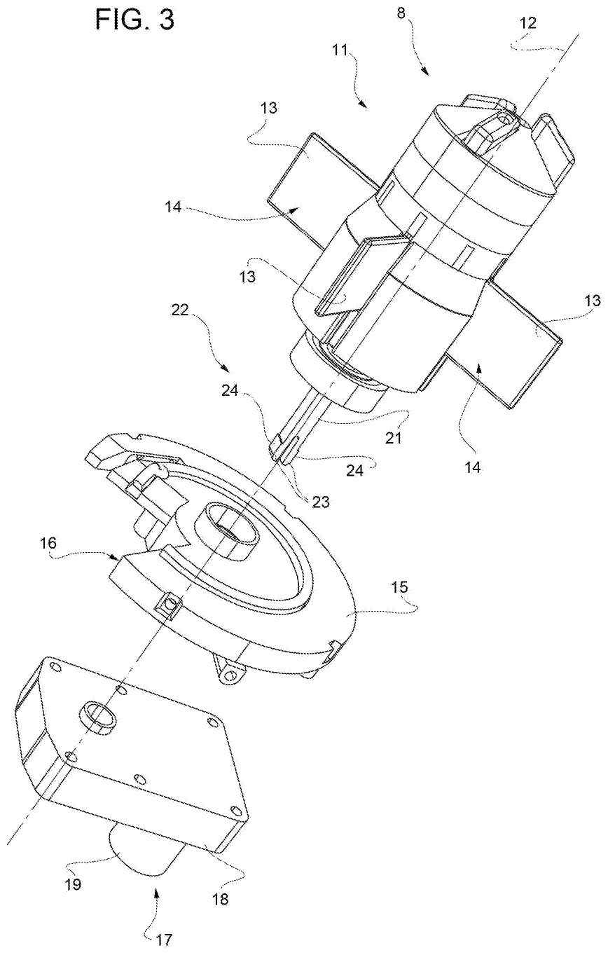

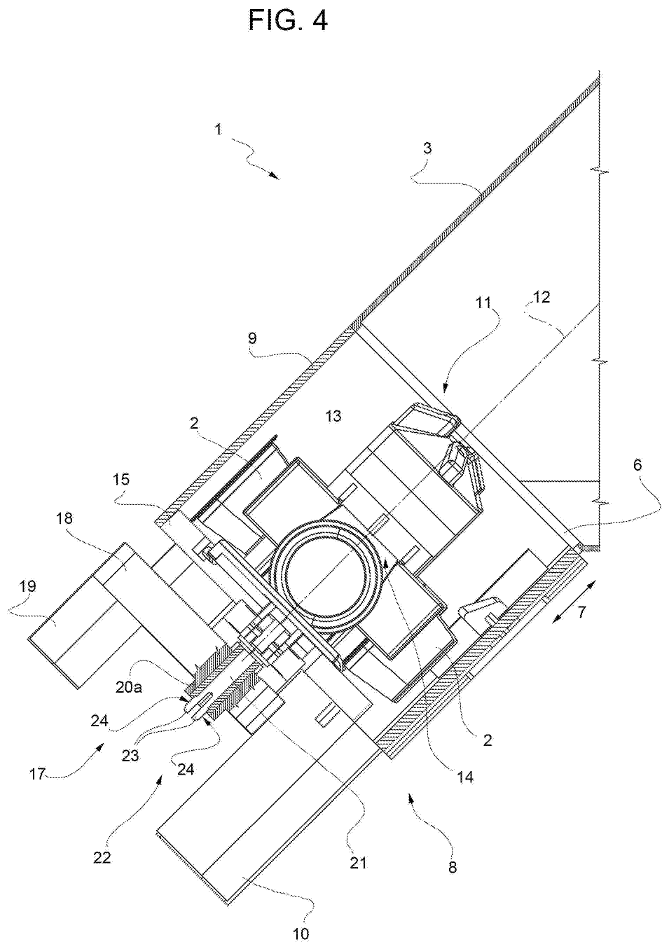

In the dispenser 1 shown in FIGS. 1 to 4, each container 2 has a shape of a substantially truncated cone capsule, and is fed in the respective pocket 14 with a random orientation, i.e. with its own larger base radially arranged inwards or outwards from the respective pocket 14.

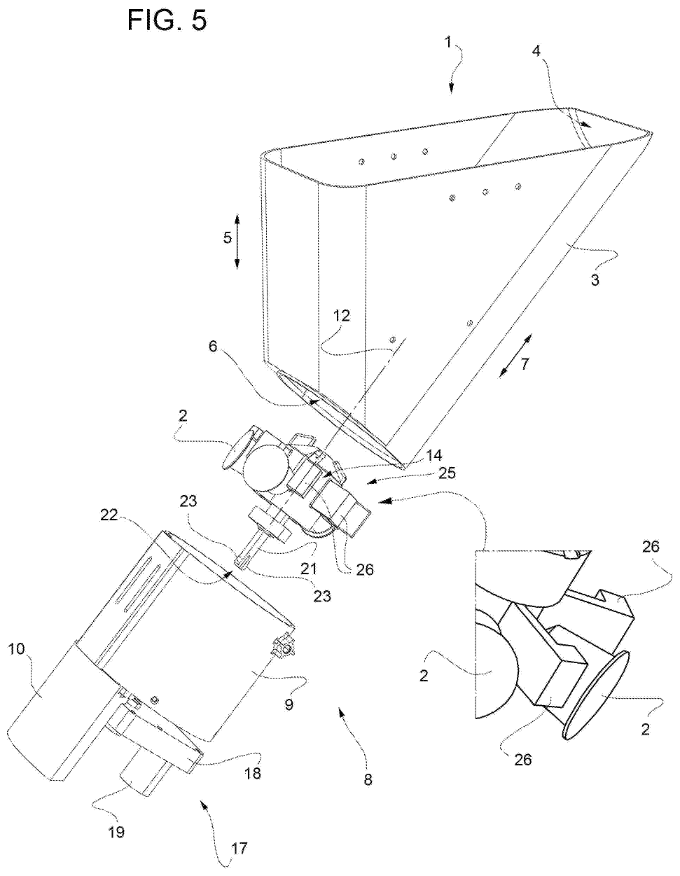

The embodiment shown in FIG. 5 differs from the one shown in FIGS. 1 to 4 solely in that the wheel 11 is replaced with a dispensing wheel 25 similar to the wheel 11 and provided with a plurality of dragging members 26 evenly distributed around the axis 12 and extending radially outwards from an outer surface of the wheel 25.

Each member 26 is substantially L-shaped in a section plane perpendicular to the rotation axis 12 of the wheel 25, which shape allows the pockets 14 to receive the containers 2 all with the same orientation, i.e. with the larger bases arranged radially outwards.

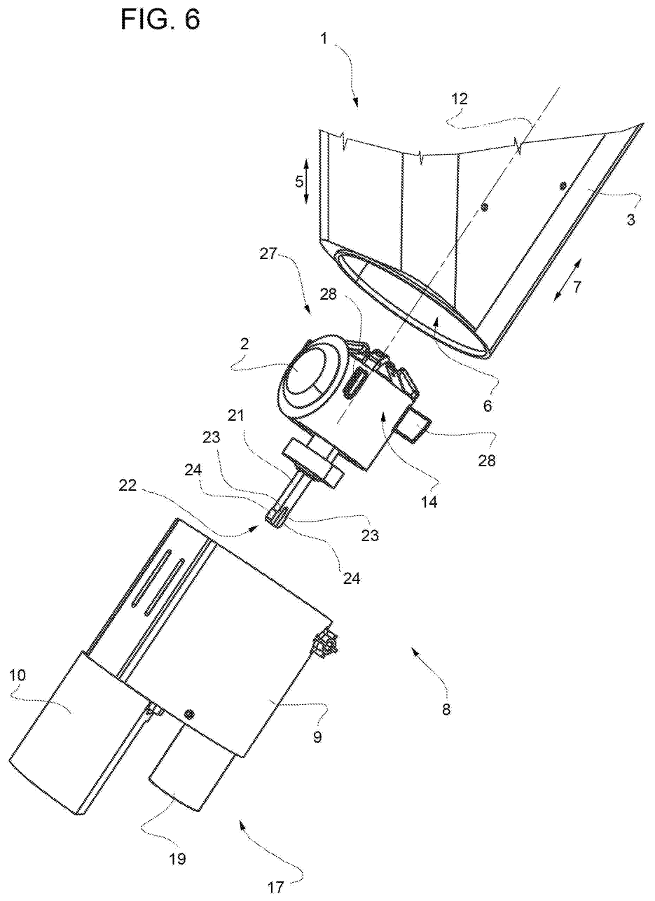

The embodiment shown in FIG. 6 differs from the one shown in FIGS. 1 to 4 in that the wheel 11 is replaced with a dispensing wheel 27 similar to the wheel 11 and provided with a plurality of dragging members 28, which are evenly distributed around the axis 12, extend radially outwards from an outer surface of the wheel 11, and have a radial length shorter than a radial length of the elements 13.

In the embodiment shown in FIG. 6, the containers 2 have the shape of a substantially truncated cone pod, and are fed in the corresponding pockets 14 all with the same orientation, i.e. with the larger bases arranged radially towards the inside of the respective pockets 14.

The dispenser 1 is advantageous because the wheels 11, 25, 27 are interchangeable and allow the dispenser 1 to be relatively easily and rapidly reconfigured depending on the shape and/or size of the disposable containers 2, so avoiding replacement of the hopper 3 and of the discharge unit 8.

1-10. (canceled)

11. A dispenser of disposable containers for preparation of beverages, the dispenser comprising:
a hopper to contain a plurality of disposable containers;
a discharge unit to discharge the plurality of disposable containers;
a dispensing wheel to receive disposable containers of the plurality of disposable containers from the hopper and to dispense the disposable containers to the discharge unit, the dispensing wheel is mounted to rotate about a rotation axis, the dispensing wheel including pockets each to receive at least one disposable container of the plurality of disposable containers; wherein the dispensing wheel is interchangeable to reconfigure the dispenser depending on the shape and/or size of the disposable containers;
an actuating device to rotate the dispensing wheel about the rotation axis; and
coupling means are provided to releasably connect the dispensing wheel to the actuating device.

12. The dispenser of claim 11, wherein the dispensing wheel has an input shaft configured to shape couple in an angularly fixed manner with a transmission member of the actuating device.

13. The dispenser of claim 12, wherein the input shaft and the transmission member have respective coupling portions each of which is bounded by at least one respective flat coupling face parallel to the rotation axis.

14. The dispenser of claim 12, wherein the input shaft includes coupling means to couple with the transmission member in an axially fixed manner.

15. The dispenser of claim 13, wherein the input shaft includes at least two elastically deformable projections designed to slidingly engage the transmission member and to axially lock the input shaft on the transmission member responsively to an axial insertion of the input shaft into the transmission member.

16. The dispenser of claim 11, wherein the discharge unit includes a discharge channel to discharge the disposable containers from the dispenser, and a dispensing plate that bounds the pockets of the dispensing wheel at a bottom thereof, and has an opening at the discharge channel.

17. The dispenser of claim 11, wherein the dispensing wheel has a plurality of dragging members, each of which tangentially bounds, together with each adjacent dragging member of the plurality of dragging members, a respective pocket.

18. The dispenser of claim 17, wherein each of the plurality of dragging members has a substantially flat shape.

19. The dispenser of claim 17, wherein each of the plurality of dragging members is substantially L-shaped on a plane perpendicular to the rotation axis of the dispensing wheel.

20. The dispenser of claim 11, wherein the actuating device is mounted on the discharge unit.
